(19) United States
(12) Patent Application Publication
(10) Pub. No.: US 2005/0123137 A1
(43) Pub. Date: Jun. 9, 2005

(54) Means for providing protecting for digital assets

(76) Inventor: Peter McCallum, Palm Beach (AU)

Correspondence Address: Brink Hofer Gilson & Lione, P O Box 10395, Chicago, IL, 60610, US

(21) Appl. No.: 10/488,484

(22) PCT Filed: Jul. 1, 2003
(86) PCT No.: PCT/AU03/00845

(30) Foreign Application Priority Data
Dec. 13, 2002 (AU) 2002953325

(51) Int. Cl. H04K 1/00

(52) U.S. Cl. 380/255

(57) ABSTRACT

A system for providing protection for identified digital assets, the system including: (1) a central control system (210); (2) a client terminal (220) able to communicate via a computer network (230) with the central control system (210); (3) client software (240) resident on each client terminal (220); (4) a master copy of a digital asset (250) stored on the central control system (210); (5) an encrypted copy of the digital asset (260) stored on the client terminal (220), with an encryption key for the encrypted copy of the digital asset stored on the central control system (210) and the client terminal (220); whereby, the client software (240) resident on the client terminal (220) controls access by a custodian (280) to the copy of the digital asset (260) stored on the client terminal (220), and the custodian's level of access to the copy of the digital asset (260) stored on the client terminal (220) can be altered from the central control system (210). A method and computer readable medium of instructions are also disclosed.

### TECHNICAL FIELD

The present invention relates to the security and protection of digital data, information, files and the like, and in particular, to a method, system and computer software for providing protection for digital assets; i.e. digital data, information, files and the like, that facilitates digital assets to be controlled, managed and/or monitored from a central facility.

### BACKGROUND ART

A Digital Asset (DA) is a digital text, graphic, sound, electronic record, etc., and includes digital data, information, files and the like, and is preferably, but not necessarily, identified as an item of value, confidential information and/or intellectual property whose compromise would cause significant damage to an individual, enterprise, organisation or the like. Unauthorized access to a DA may constitute potentially significant damage to interests of the rightful owner, licensee, etc.

There is heightening awareness of the increasing exposure of digital assets to misappropriation, misuse or damage. This awareness may take the form of a general feeling of unease, a sense of helplessness, even a denial of its relevance. Threats are multiplied by steadily increasing proliferation of distributed equipment (for example laptop computers). Many organisations are exposed by, for example, the ability of a person to leave an office with a pocket full of computer disks, or send via email files, containing potentially millions of dollars of confidential information, intellectual property or data vital to the security of the nation, or embarrassing or compromising a nation's international relations.

Corporate information officers are faced with potential or actual demands for effective DA protection. A solution is not presently known which is cost-effective, allows efficient authorized access, has pre-emptive capability and is itself subject to external monitoring.

Digital assets resident on central mainframe systems and totally restricted to that platform are generally least at risk. However, increasingly, application systems require DA's be distributed to remote processors including highly mobile PC's, such as laptop computers. Current security tools are largely irrelevant when the DA's reside on a distributed processor's hard disk. Loss of custodial control of the distributed processor increases the likelihood of unauthorized personnel or other users accessing DA's for whatever purpose they might desire.

Presently, systems are not available that enable real-time implementation of functions providing control intervention and action to recover or deny unauthorized access to digital assets. Protection should be able to be applied whether a terminal holding a DA is network connected or unconnected. Most existing defence mechanisms are passive in action, in that they rely on denying access or service, as per an originally installed security tool.

Specific instances of existing threats can include:
Stolen machines, potentially resulting in loss of confidential information or intellectual property;
Stolen HDD, potentially resulting in loss of confidential information or intellectual property;
Unknown/unauthorized copying of digital assets, potentially resulting in loss of confidential information or intellectual property (HDD, FD, CD, Printer);
Digital assets are not universally protected when distributed;
No real-time control of relationships—eg. for custodians, digital assets and laptops;
No ‘audit strength’ management verification of approved relationship—Custodians, Digital Assets and laptops;
Unusual or suspect patterns of unconnected laptop operations are not monitored, queried or responded to in terms of changed digital asset access;
Digital asset content within a file may not be identified as a digital asset and consequently not receive the required protection.

In a networked data communications system, users have access to terminals which are capable of requesting and receiving information from local or remote information sources that may contain digital assets. In such a system a terminal may be a type of processing system, computer or computerised device, a personal computer (PC), a mobile or cellular phone, a mobile data terminal, a portable computer, a personal digital assistant (PDA), a pager, a thin client, or any other similar type of electronic device. The capability of the terminal to request and/or receive information can be provided by an application program, hardware or other such entity. A terminal may be provided with associated devices, for example a storage device such as a hard disk drive or solid state drive, both internal and external.

A computer network as referenced in this specification should be taken to include all forms of connected or communicating computers or terminals having at least two terminals adapted to communicate with each other. That is, the term computer network should be taken to include any type of terminal, computer, computerised device, personal digital assistant peripheral computer equipment, computerised accessory, mobile or cellular phone, digital electronic device or other similar type of computerised electronic device or part thereof which is rendered such that it is capable of communicating with at least one of any of the aforementioned entities. The communication of information or data can occur over any computer network, data communications network, telecommunications network, wireless network, internetwork, intranetwork, LAN, WAN, the Internet and developments thereof, transient or temporary network, combinations of the above or any other type of network providing for communication between computerised, electronic or digital devices.

This identifies a need for a method, system and/or computer readable medium of instructions for providing protection for digital assets which overcomes or at least ameliorates the problems inherent in the prior art.

### DISCLOSURE OF INVENTION

In a broad form of the present invention, the invention seeks to provide a Digital Asset Protection (DAP) system designed to enable an enterprise to apply extended control over creation, custody, copy distribution and access of certain intellectual assets (Digital Assets). Authorized custodians of encrypted DA copies may have their custodian authorization status varied or cancelled at any time with consequent variation to particular DA copy access. DA copies may also have their protection level status varied at any time with similar possible re-statement and application of changes to allowable DA access.

Preferably, the DAP system operates on a client-server basis with both push and pull characteristics. A required frequency of network connection can be monitored to ensure application of current protection level variations. Custody of DAP client resident equipment can also be monitored. The DAP system administration function may cause a client terminal to be disabled or DA access constrained at any time. DA's are preferably held encrypted in both master and copy situations. The extent of client use of DA's can also be managed.

The DAP system seeks to protect against unauthorized access, or where such access is initiated to deny DA availability, by destroying the distributed copy and/or the means to decrypt. In order to achieve this, the DAP system seeks to verify that a specific terminal is in the custody of an authorized custodian and has the correct storage device, for example HDD, installed. Relevant to protection levels required (plevels), the DAP system can maintain the, encrypted status of all DAs in the system. Where attempts to access DAs are deemed invalid and are detected, the DAP system response may result in, for example, over-written destruction of decryption keys, DAs, clients, HDD contents and/or BIOS.

At least three significant issues are thereby addressed:
Knowledge of the location of every digital asset (text, graphic, sound, video, etc.);
Central and real-time control of distributed existence and access;
Attempts to circumvent control can be recorded, defeated and the related digital asset copy destroyed.

The DAP system can enable real-time corporate control of all occurrences of corporate DAs at any point on a distributed network and can exercise control over DAs even if the terminal does not connect to the network. DA's are preferably held encrypted and transmitted encrypted. Encrypt/decrypt keys can be controlled via a separate key server.

The present invention can also address the common situation in organisations where any user can use any (within reason) workstation or terminal. In this situation there is not necessarily a one-to-one relationship between a user and a particular terminal, except, for example, perhaps in the case of a laptop computer, where a one-to-one rule may be enforced. This embodiment of the invention addresses multiple-users per workstation. Also, group-based security is addressed, enabling all members of a workgroup to be treated under a common security policy.

The term “custodian” is used throughout the specification and should be read as a reference to an individual custodian or a group of individual custodians. For example, where a group of individuals, such as a workgroup or team, is provided with common security privileges, then the workgroup or team can be collectively referred to as a custodian.

Files are encrypted/decrypted using an encryption/decryption key. The encryption key (or equivalently the decryption key) itself can be further encrypted with a public/private key which depends, for example, on the custodian and custodian level of authorisation. The encryption key itself may also be further encrypted with, for example, a custodian password.

Use of the term “encryption key” or “decryption key” as used herein should be taken as a reference to any type of digital key, certificate, credential, password or the like which effects cryptographic concealment of digital assets. This includes all forms of encryption keys, for example, symmetric keys, private keys, public keys, further encrypted encryption keys, simple passwords, and the like. An encryption key or decryption key could also be further encrypted using external data present on some external device, such as, but not restricted to, USB storage, smart card, finger print, iris scan or other biometric information.

In a broad form the present invention provides a system for providing protection for identified digital assets, the system including:
(1) a central control system;
(2) a client terminal able to communicate via a computer network with the central control system;
(3) client software resident on the client terminal;
(4) a master copy of a digital asset stored on the central control system;
(5) an encrypted copy of the digital asset stored on the client terminal, with an encryption key for the encrypted copy of the digital asset stored on the central control system and the client terminal;
whereby, the client software resident on the client terminal controls access by a custodian to the copy of the digital asset stored on the client terminal, and the custodian's level of access to the copy of the digital asset stored on the client terminal can be altered from the central control system.

According to a particular embodiment of the present invention, when access is initially requested to the encrypted copy of the digital asset by the custodian the client software attempts to communicate with the central control system and authenticate the initial access request.

In a particular embodiment, the present invention further provides that when access is properly requested to the encrypted copy of the digital asset residing on the client terminal, and the client terminal is disconnected from the central control system, the copy of the digital asset can be decrypted and used by a custodian with defence mechanisms active.

Preferably, the digital asset is assigned a level of protection, and the at least one custodian is assigned a level of authorisation. Different levels of protection/authorisation can allow varying use of each copy of the digital asset.

In a particular embodiment, the present invention further provides:
(A) if the central control system authenticates the initial access request, a private decryption key is used to enable the encrypted copy of the digital asset to be decrypted; or,
(B) if the central control system does not authenticate the initial access request, the decryption key is not available to be used to decrypt the encrypted copy of the digital asset.

Preferably, after the initial access request to the central control system, when further access to the copy of the digital asset is requested by a custodian the client terminal is not required to further connect to the central control system as a unique key has been allocated and resides on the client terminal. The client software can perform authorisation checks.

In a further particular embodiment, the central control system includes a communications controller and a encryption key register. In yet a further particular embodiment, the central control system includes a digital asset register to store current and previous master copies of the digital asset. In yet a further particular embodiment, the central control system includes a digital asset register to register and store each encrypted copy that has been distributed at the request of a properly authenticated client terminal. In yet a further particular embodiment, the central control system includes a digital asset transaction log record. In yet a further particular embodiment, the central communications controller includes a client communications module and a central communications module.

The present invention according to another possible aspect provides that the central control system is provided by at least two physical servers. The present invention according to still another possible aspect provides that the communications controller is resident on a first server, and the encryption key register is resident on a second server. The present invention according to still another possible aspect provides that all functions other than the communications controller are resident on the second server. The present invention according to still another possible aspect provides that the encryption key register stores additional information for the authentication of any request to copy a digital asset. The present invention according to still another possible aspect provides that the additional information relates to the identity of the custodian and/or a specific authorised client terminal.

An aspect of the embodiment utilising separate servers, which may be more than two physical servers, is that encryption keys are not held on the same machine as the encrypted DAs. Likewise, authentication factors can be held separately to active data authenticated by such factors.

In one form, each client software package uniquely controls the decryption process for a particular client terminal. In a further form, the client software controls access and/or destruction of the copy of the digital asset.

In a particular embodiment of the present invention, the client software includes a poison pill module. In this form, the poison pill module can cause the destruction of the copy of the digital asset. In a further particular embodiment of the present invention, the poison pill module checks a value identifying the client terminal, or a component thereof, against an expected value. In one form, the poison pill module checks a component of a hash-sum value, combined with custodian information, a client terminal and hardware reference against expected values.

In a further particular embodiment of the present invention, the client software includes a power-on control monitor; the client software includes a communications handler; the client software includes an exception handler; the client software includes an encryption handler; and the client software includes an I/O interruption handler.

Preferably, authorisation and protection levels can be updated on the central control system and transmitted to the client software on the client terminal.

In a further broad form the present invention provides a method of providing protection for digital assets, the method including the steps of:
(1) storing an encrypted master copy of a digital asset on a central control system;
(2) storing a separate encrypted copy of the digital asset on a client terminal provided with client software, the client terminal able to communicate via a computer network with the central control system;
(3) storing an encryption key for the encrypted copy of the digital asset on the central control system and the client terminal; and,
(4) when access is properly requested by an authorised custodian to the encrypted copy of the digital asset residing on the client terminal, and the client terminal is disconnected from the central control system, the client software controls access to the copy of the digital asset.

In a particular embodiment, if preset authorisation criteria are not met the client software can effect destruction of the encryption key, the copy of the digital asset on the client terminal, the contents of memory and/or storage facilities of the client terminal, and/or BIOS information for the client terminal. In yet a further particular embodiment, the copy of the digital asset is destroyed if successful network connection to the central control system is not achieved after a preset number of attempts and/or a preset time period. In yet a further particular embodiment, the central control system tracks the location of all copies of each digital asset. In yet a further particular embodiment, a newly created digital asset is uploaded to the central control system to create a master copy of the digital asset. In yet a further particular embodiment, the copy of the digital asset is periodically re-encrypted and redistributed. In a further particular embodiment of the present invention, print and copy functions of the client terminal can be optionally disabled by the client software.

In still a further broad form the present invention provides a computer readable medium of instructions for providing protection for digital assets in a system including:
(1) a central control system;
(2) a client terminal able to communicate via a computer network with the central control system;
(3) a master copy of a digital asset stored on the central control system;
(4) an encrypted copy of the digital asset stored on the client terminal, with the encryption key for the encrypted copy of the digital asset stored on the central control system and the client terminal;
whereby the computer readable medium of instructions is adapted to control access by a custodian to the copy of the digital asset stored on the client terminal, and the custodian's level of access to the copy of the digital asset stored on the client terminal can be altered from the central control system.

Preferably, according to one embodiment, the client software controls the decryption process, and/or, the client software includes a poison pill module.

### BRIEF DESCRIPTION OF FIGURES

The present invention should become apparent from the following description, which is given by way of example only, of a preferred but non-limiting embodiment thereof, described in connection with the accompanying figures.

FIG. 1 illustrates a processing system forming part of the invention.

FIG. 2 illustrates an embodiment of the present invention, wherein the figure shows an overview of the system.

FIG. 3 illustrates an embodiment of the present invention, wherein the figure shows the central control system.

FIG. 4 illustrates an embodiment of the present invention, wherein the figure shows the client terminal and client software.

FIG. 5 illustrates the pclient installation process.

FIG. 6 illustrates a pclient POST check process.

FIG. 7 illustrates a pclient integrity check process.

FIG. 8 illustrates a pclient integrity violation process.

FIG. 9 illustrates a pclient Kill process.

FIG. 10 illustrates a pclient custodian authentication process.

FIG. 11 illustrates a pclient DA encryption/decryption/interdiction process.

FIG. 12 illustrates a pclient DA copy management process.

FIG. 13 illustrates a pclient DA copy upload process.

FIG. 14 illustrates a pclient log management process.

FIG. 15 illustrates a pcentral installation process.

FIG. 16 illustrates a pcentral customisation and administration process.

FIG. 17 illustrates a pcentral audit checks process.

FIG. 18 illustrates a pcentral administration process dependent on GUI location.

FIG. 19 illustrates a pcentral pclient/custodian authentication process.

FIG. 20 illustrates the architecture design of a particular embodiment.

FIG. 21 illustrates the database design of a particular embodiment.

FIG. 22 illustrates the pclient architecture design of a particular embodiment.

### MODES FOR CARRYING OUT THE INVENTION

The following modes are described in order to provide a more precise understanding of the subject matter of the present invention.

### I. Preferred Embodiment

In the figures, incorporated to illustrate the features of the present invention, like reference numerals are used to identify like parts throughout the figures.

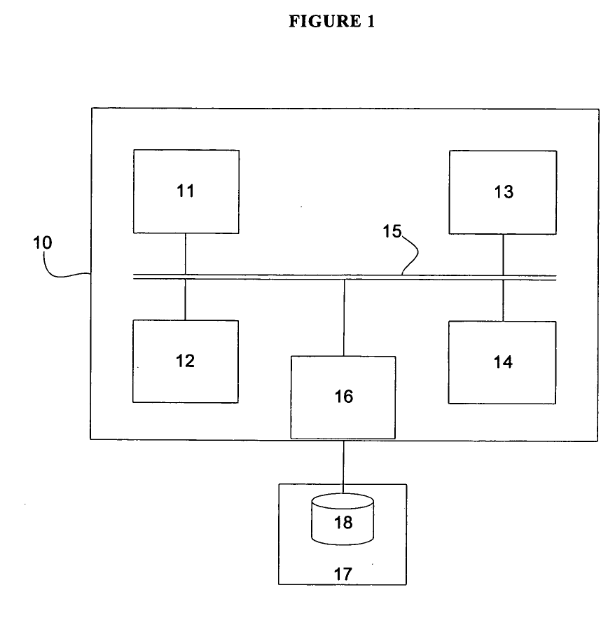

A particular embodiment of the present invention can be realised using a processing system providing a client terminal, an example of which is shown in FIG. 1. In particular, the processing system 10 generally includes at least a processor 11, a memory 12, an input device 13 and an output device 14, coupled together via a bus 15. An external interface 16 can be provided for coupling the processing system 10 to a remote storage device 17 (e.g. associated with a central control system) which houses a database(s) 18. The memory 12 can be any form of memory device, for example, volatile or non-volatile memory, solid state storage devices, magnetic devices, etc. The input device 13 can include, for example, a keyboard, pointer device, voice control device, etc. The output device 14 can include, for example, a display device, monitor, printer, etc. The remote storage device 17 can be any form of storage means, for example, volatile or non-volatile memory, solid state storage devices, magnetic devices, etc.

In use, the processing system 10 is adapted to allow data or information to be stored in and/or retrieved from the database 17. The processor 11 receives instructions via the input device 13 and displays results to a user via the output device 14. It should be appreciated that the processing system 10 may be any form of processing system, computer terminal, server, specialised hardware, or the like.

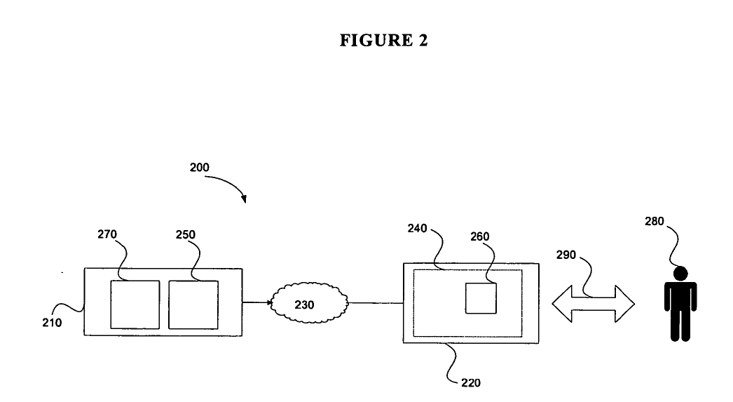

Referring now to FIG. 2, an overview of the digital asset protection system is illustrated. The system 200 includes the central control system 210 and a client terminal 220 which are able to communicate via computer network 230. Client software 240 is resident on the client terminal 220. A master copy of a digital asset 250 is stored on the central control system 210. An encrypted copy of the digital asset 260 is stored on the client terminal 220 and the central control system 210. The encrypted copy of the digital asset 260 corresponds to the encrypted master copy of the digital asset 250 but with a different key. A master key is not sent to the client terminal.

The encryption key (or equivalently the decryption key) is stored in an encryption key register 270 on the central control system 210. A copy of the encryption/decryption key is stored on the client terminal 220 which controls access to the encrypted copy of the digital asset 260. The encryption key stored on the client terminal 220 is unique to that particular client terminal 220, a copy of this encryption key is stored in the encryption key register 270 on the central control system 210. Only when a user 280 initially requests access to the encrypted copy of the digital asset 260 via the client terminal input/output means 290, does the client software 240 attempt to initiate communication with the central control system 210 via the network 230 and authenticate the access request. Subsequent requests for access to the encrypted copy of the digital asset 260 via the client terminal input/output means 290 do not require the client software 240 to initiate communication with the central control system 210 via the network 230 as the client terminal 220 now contains the unique encryption key and access to the copy of the digital asset 250 is controlled by client software 240.

The user 280 is only granted access to the encrypted copy of the digital asset 260 when the user 280 is an authorised custodian having been assigned access privileges to the digital asset. When access is properly requested by an authorised custodian to the encrypted copy of the digital asset 260 residing on the client terminal 220, and the client terminal 220 is disconnected from the central control system 210, the copy of the digital asset 260 can be decrypted and used by the custodian 280 with defence mechanisms active. Hence, it is not always necessary that the client terminal 220 be in communication with the central control system 210 to allow an authorised custodian access to the encrypted copy of the digital asset 260.

It is possible that more than one custodian 280 can be assigned access to a master copy of the digital asset 250. A digital asset is assigned a level of protection and the custodian 280 is assigned a level of authorisation. The copy of the digital asset 260 is always stored on the client terminal 220 in an encrypted format, also preferably, the master copy of the digital asset 250 is also stored on the central control system 210 in an encrypted format. Different levels of digital asset protection and custodian authorisation allow varying use of the copy of the digital asset 260 by the custodian 280. Varying use of the copy of the digital asset 260 includes, for example, that the digital asset 260 is provided to the custodian 280 as “read only”, “update”, “locked”, etc.

When access to the copy of the digital asset 260 is requested at the client terminal 220 which is in communication with the central control system 210, if the central control system 210 authenticates the access request, the decryption key on the client terminal 220 is used to enable the encrypted copy of the digital asset 260 to be decrypted. If the central control system 210 does not authenticate the access request, the decryption key is not available to be used to decrypt the encrypted copy of the digital asset 260, for example the client terminal 220 may contain an old decryption key that is no longer valid due to the encryption key register 270 having been updated. The central control system 210 can also contain an exact copy of the encrypted copy of the digital asset 260 in addition to the master copy of the digital asset 250.

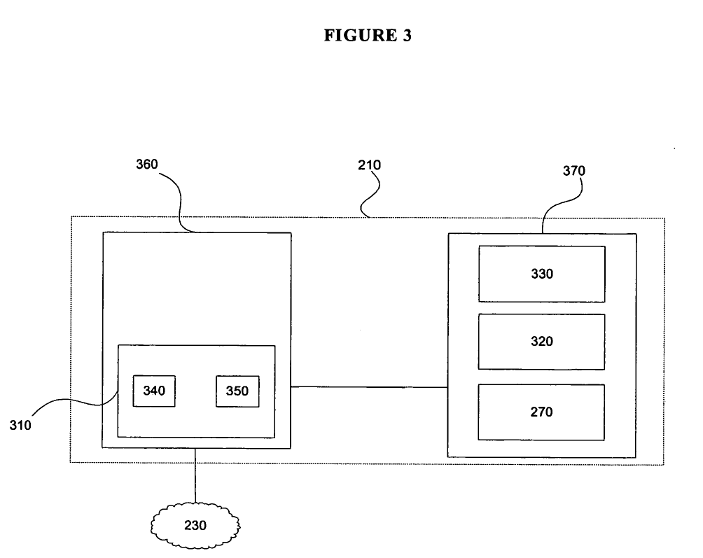

Referring to FIG. 3, the central control system 210 includes a communications controller 310 and an encryption key register 270. The central control system 210 also includes a digital asset register 320 which is able to store current and previous master copies of digital assets. The digital asset register 320 registers and stores each uniquely encrypted copy that has been distributed at the request of a properly authenticated client terminal 220. Preferably, the central control system 210 also includes a digital asset log record 330. The central communications controller 310 includes a client communications module 340, which controls communications with the client terminal 220, and a central communications module 350, which controls communications within the central control system 210.

As is illustrated in FIG. 3, the central control system 210 is split over at least a first physical server 360 and a second physical server 370. The functions of the central control system 210 are allocated to one or other of the physical servers 360 or 370 to provide additional security. For example, external access to the central control system 210 is only by way of the first physical server 360. Records of digital assets stored on the central control system 210 are accessed only by way of the second physical server 370. Hence, the first physical server 360 can act as a secure gateway between the computer network 230 and the digital asset register 320 and the encryption key register 270.

The encryption key register 270 can also store additional information for the authentication of any access request to a copy of a digital asset 260. Such additional information could relate to the identity of the custodian and/or details of an authorised client terminal 220.

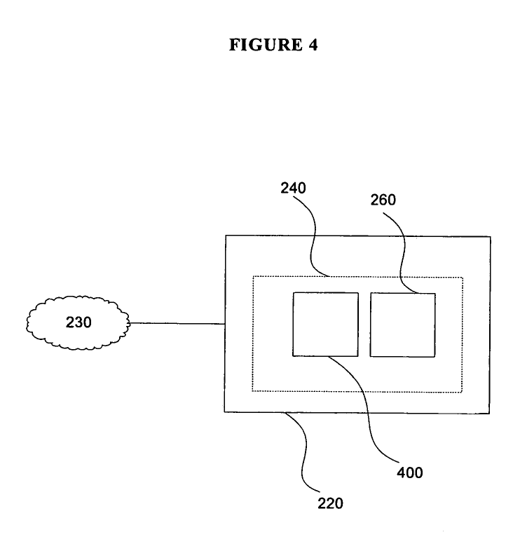

Referring to FIG. 4, the client software package 240 resident on a client terminal 220 uniquely controls the decryption process for a particular copy of the digital asset 260 on a particular client terminal 220. The client software 240 also controls access and/or destruction of the copy of the digital asset 260 on the client terminal 220.

The client software package 240 includes a poison pill module 400. The poison pill module 400 can cause the destruction of the copy of the digital asset 260. The poison pill module 400 checks a retrieved value or reference number for the client terminal 220, or a component thereof, against an expected value or reference number; which can be stored in, for example, the poison pill module itself, in another part of the client software 240, or in the digital asset encryption key register 270. Preferably, the poison pill module 400 checks a component of a hash-sum value, combined with custodian information and a client terminal and hardware reference code(s) (for example a hard disk drive (HDD) reference code(s)) against expected values.

The client software 240 can additionally include a power-on control monitor as an additional security measure. The client software 240 is also provided with a communications interface which handles communications via the computer network 230. Additional modules or functions are included in the client software 240 as described elsewhere.

At any required time the authorisation and protection levels can be updated on the central control system 210 and transmitted to the client software 240 on the client terminal 220. The frequency of computer network 230 access can also be monitored by the client software 240, and if the frequency of access is not satisfactory access requests to the copy of the digital asset 260 may be denied.

If certain criteria are not met the client software 240 can cause the destruction of the encryption/decryption key on the client terminal 220, the copy of the digital asset 260 itself, the contents of memory and/or storage facilities of the client terminal 220, and/or BIOS information for the client terminal 220. The copy of the digital asset 260 can also be destroyed if successful network connection to the central control system 210 is not achieved after a preset number of attempts and/or preset time period. The central control system digital asset transaction log record 230 can, for example, record the location of all copies of each digital asset and log record events. There can be provided separate copy registries recording copy states.

When a new digital asset is created on a client terminal 220, the digital asset is uploaded encoded to the central control system 210 via the network 230 to create a master copy of the digital asset 250. This can the be assigned an encryption/decryption key which is stored in the encryption key register 270 and the encrypted copy of the digital asset retransmitted to the client terminal 220.

Copies of the digital asset are preferably periodically re-encrypted and redistributed.

### II. Various Embodiments

The following description describes further non-limiting embodiments of the present invention.

Architecture—General

Digital Assets (DAs) are identified by an enterprise, organisation, creator, etc. and the required level of protection (plevel) is assigned. Individuals, or groups of individuals, (custodians) are identified as approved to receive copies of DAs. A custodian may be treated as a group of individuals in many instances, for example, multiple-users per workstation or common workgroup-based security. A custodian is assigned a protection level appropriate to his or her ‘need to know’ status. This ‘Custodian plevel’ is matched to DA plevels on an equal or less basis when responding to request for DA copy distribution. A Digital Asset Protection (DAP) central control facility tracks all DA masters and distributed copies during their lifetime and seeks to protect against unauthorized access or possession. DAs may only be accessed as facilitated by the DAP central control facility (pcentral, i.e. central control system). DAs are held encrypted wherever located and copies are uniquely encrypted for each custodian.

DAs may be generated by custodians in which case the DAP system can upload the new DA and create a DA master for enterprise authorized availability. Varying restrictions regarding access are applied to DA copies relative to the plevel assigned to each DA. Protection against unauthorized access or possession of DAs (copies) is afforded for custodians when both network connected and unconnected. Levels of protection and authorizations may be varied in real time and applied to the custodian's pclient at the next network connect. Distributed copies are each uniquely encrypted. Only authorized custodians may receive a copy. Each copy is uniquely encrypted for that custodian. Each DA master and copy is assigned a protection level (plevel) which defines the degree of protection to be afforded this DA master of copy. The encryption/decryption key can also depend on the plevel to ensure higher levels of security. Distributed DA copies remain subject to DAP pclient control. Pclients control decryption, access and possible destruction of copies. Protection control variables may be modified in real-time and become operational as soon as the variable is downloaded to the pclient. Relationship between machines, hardware, HDD's, custodians and clients are controlled and may be queried in real time.

Each copy is distributed and distribution is preferably time-stamped and logged. DAs are held and transmitted in encrypted form as required. Each encrypted DA master and copy is subject to a unique and separately managed key. Each DA distributed (uniquely encrypted) copy has the receiving custodian recorded. Where a custodian attempts to pass a DA to another point, the result would be an encrypted file without key. This ensures that copies may not be shared between distributed clients.

Where DA encryption is aged beyond a set time period, the DA can be re-encrypted and redistributed. This increases difficulty when attempting remote encryption-cracking. Encrypted DAs and respective key are preferably not ever transmitted together. Encryption keys are separately controlled from the central site.

Connection to the network immediately invokes execution of a process to audit distributed DAs and their resident custodial locations. DA custodians which no longer have authorization for specific DAs may have those DAs deleted and overwritten. Where a laptop possession is determined to be unauthorized, the connection point can be immediately made known to physical asset security control for recovery.

A Poison Pill function is provided that can be activated which may delete/overwrite distributed DAs, destroy the DAP client (pclient), inactivate BIOS after a set number of power-ons (e.g. 3 power-on), or immediately if activated by a DAP system administrator. Poison pill code and invocation points are checked for unchanged presence and any unauthorized modification is logged and optionally the device is inhibited from accessing the DA. Laptops can have printing and copying of DAs optionally disabled by routing copying and printing and print screen functions through the poison pill module. The poison pill can destroy all function and data if there is an attempt to interfere with the poison pill. Periodic character comparisons with the DA client registry at DAP Central (pcentral) can occur. There can also be allowance made for inclusion in a ‘ghost’ image load, if required.

Logical Design—General

The DAP system pcentral functions preferably operate from two (or more) logical servers. Server 1 communicates only with the pcentral communications handler and has no other communications connections. An objective is to isolate encryption keys and critical control and protection variables from general browser access. Server 1 may be physically located outside the system programming operating envelope. No staff would have uncontrolled access to server 1 content.

| Server 1 | Server 2 | pcentral | pclient | Poison pill |
|---|---|---|---|---|
| Y | | Poison pill registry | Poison pill | S-key |
| Y | | Encryption selector | | I-Key |
| Y | | M-Key | | Encryptor |
| Y | | I-Key | | Interdictor |
| Y | | S-Key | | Machine |
| Y | | Custodian | | Custodian |
| | Y | Machine | | Passwords |
| | Y | Client | client | Bio-metrics |
| | Y | | Read handler | |
| | Y | | Write handler | |
| | Y | DA Master | | |
| | Y | DA Copies | DA copies | |
| | Y | Msg & Sig handler | Msg & Sig | |
| | | | handler | |
| | Y | Comms handler | Comms handler | |
| | Y | Logrec handler | | |
| Y | | Admin Handler - | | |
| | | server 1 | | |
| | Y | Admin Handler - | | |
| | | server 2 | | |

The process on the client machine is as follows:

| | | | DAP | |
|---|---|---|---|---|
| | | | Modules | Note |
| Seq | Logical action | DAP action | called | follows |
| 1 | Turn on machine | Do start up checks | AA, BB, CC | |
| | | Do authentication | XX3 | |
| | | Kill if any check fails | GG1, 2 | |
| 2 | Do BIOS execs | | | |
| 3 | Start DOS | | | |
| 4 | Start Windows | | | |
| 4.1 | Determine if client | Connect to network, | NN | |
| | machine network is | servers | | |
| | connecting to DAP | Upload/download and | | |
| | control servers = Yes | action any transactions. | | |
| | | Reset POST-count to ‘0’ | | |
| 4.2 | Determine if client | Post-count = Post-count + 1. | AA | |
| | machine network | If post-count exceeds | GG | |
| | connected to DAP | maximum then lock/kill | | |
| | control servers = No | DAP client and DA | | |
| | | content | | |
| 5 | Start applications | | | |
| 6.1 | Application executes | Request DA read | DD | |
| | an Open file as input | authorization, Interdiction = ON | | |
| | command: detect DA | (file unique) | | |
| | catalog access (I/O | May require | | |
| | interrupt) | fingerprint/password | | |
| | | intervention if plevel is | | |
| | | high value | | |
| 6.2 | Application executes | Request DA read | DD | |
| | an Open file as | authorization, Interdiction = ON | | |
| | output command: | (file unique) | | |
| | detect DA catalog | | | |
| | access (I/O interrupt) | | | |
| | or query is this to be | | | |
| | a DA output file? | | | |
| 7 | Read file: detect | Decrypt (block by block) | RR2 | |
| | request to read block | | | |
| | (I/O interrupt) | | | |
| 8 | Assemble I/O | Normal application | FF | |
| | Workspace plain text | function, | | |
| | prefer encrypted? | Phrase checker detects | | |
| | | output DA subject | | |
| 9 | Output? | Unencrypted | DD | |
| | | representation other than | | |
| | | display is barred by | | |
| | | Interdict module | | |
| 10 | Write file: File DA or | For non-DA Phrase | FF | 10.1 |
| | non-DA is identified | checker can end plain text | RR1 | |
| | at Open command. | write (see note 10.1) | | |
| | | Encrypt (block by block) | | |
| | | Record encrypted on HD | | |
| 11 | Close file: DA | Create DAP upload | DD | |
| | Catalog entry known | transaction, | | |
| | and recognized | Interdict = OFF (file | | |
| | | unique) | | |
| 12 | Close application | | | |
| 13 | Close Windows | | | |
| 14 | Close DOS | | | |
| 15 | Power OFF | | | |

1. Turn on Machine:

1.1. Test critical DAP content has not been varied/hacked.

1.2. Check allowable number of ‘power-on’ iterations since last connect has not been exceeded.

6. Open File:

6.1 Request access authorization

6.2 Turn interdict=ON.

10.1 DA recogniser. If phrase checker encounters a DA sensitive phrase then close plain-text output, open a DA output with same name plus DA and continue writing to end of file. Resultant two files may need to be concatenated as a single DA file for future processing.

Physical Design—General

DAP at Four Levels:

Implementation at hardware and BIOS level options is a possible embodiment of the present invention when implementing multiple unrelated DAP clients on a terminal. Where a person is a custodian for two or more independently varying DAP systems, each DAP system's client may reside on the same laptop. However they will necessarily stand on a single hardware and BIOS feature set. Where this causes a difficulty to arise, then independent client resident machines (multiple laptops) would be required.

Devices (FD, HD and CD) write interface: An unsaved create document is a temporary file, therefore intercept at temporary file stage.

Exposure

MS Windows copies (i.e. C:/Recycled).

At Hardware Interact

May require all equipment to be provided from a central point. The ease of remote hardware servicing (e.g. motherboard failure) should be considered. This also may require standby terminals and the return to base of defective machines.

At BIOS Interact

BIOS variation to tie-in DAP. May require all DAP authorized machines to be (‘conditioned’ and ‘ghost’ installed. May be facilitated by remote install control software.

At DOS Interact

At Windows interact

Architecture—PCENTRAL

Communications Controller

Communications between central procedures are handled separately to those with distributed clients.

Central Communicator:

Between pcentral main procedures. This unit manages all communication and protection verifications between main procedures of pcentral.

Operations Control Displays. This unit manages real-time display and interaction with the DAP administrator. Operating requests are executed in real-time or queued awaiting required connections. Where a communication is required but unavailable, a transaction is queued for immediate action when required link becomes active.

Client Communicator:

Between pcentral and pclients. Incoming transactions are virus checked, identified, validated before being passed to appropriate pcentral main procedure.

Procedure: On successful network connection and DAP connect checks, send a reset to ‘0’ command to the Client/POST/power—on routine. Operate module NN (reset power-on count to ‘0’).

DA Control Register

Operate module FF (Establish control for off-line DA create). This unit maintains content and status of current and historic Digital Assets known to this DAP. Databases required: Active DA's, Archive DA's.

Active DA's:

Record current encrypted master content and pointer to the Key register for encrypt/decrypt function key.

Archive DA's:

Maintain a date/time stamped record of previous DA's or DA versions and may be recalled and reinstated as ‘Active DA’ if required.

DA Kev Register

This unit is the point of control for all components of the DAP system. It is accessed only by the communication controller, which establishes validity of any access request. This access validation is complemented by a Key Register function, which also validates the access. Essential relationships between DA's, encryption keys, custodians, machines, and DA protection levels (plevel) are maintained. Active and Archive records are maintained. Archive records are available for perusal and possible reinstatement if required. All inter-relationships may be varied in real-time and can be immediately actioned. This action may extend to warning of missing laptops, missing laptops being reconnected to the network, and attempts to execute illegal functions.

Custodians are personnel identified as authorized at a particular DA protection level (plevel) to interact with DAs. Custodians are allocated client content and may, but not necessarily, have a laptop or desktop identified as the client ‘home’. Alternatively, an individual or group may have access to applications and files through any number of workstations in an organisation, although they may also have a specific machine ‘allocated’ to them (eg. hot-desking). This inter-relationship is frequently validated and any exception conditions are immediately utilized to protect DAs and deny access. DA protection is afforded in various ways depending upon the state of network connection.

Databases: Active keys (file, encrypt key, client), Archive keys, Active custodian (machine, plevel), Archive custodian,

Active:

Master Keys:

Are allocated to individual master DAs held by DA Master Register.

Interim Keys:

Are allocated to individual Custodian/clients to allow off-line creation of DAs. Such creation will result in pcentral being unaware of DAs created off-line. Therefore the pclient function creating the off-line DA can queue a transaction to upload the new DA. The new DA will be re-encrypted, recorded by Client Register as a DA and transmitted back to the creating pclient. This can ensure that all DAs remain in synch and are available across the DAP.

Custodians:

A real-time record of persons authorized at various plevel's to have custody of a DA with equivalent or lesser ‘plevel’. This authorization may be changed in real-time and can be applied to pclient at next network connection. DAs which are at the pclient and now not authorized, can be archived to pcentral and deleted from pclient. Subsequent reinstatement may require pclient to re-acquire necessary DAs. A register of available DAs can only be seen up to the authorized ‘plevel’.

Machines:

A real-time record of terminals (eg. laptops and desktops) assigned to or used by a custodian. The machine value is checked for current exceptions (i.e. reported lost/stolen). HDD in an invalid machine. Exception handling response may vary from a message to pclient to a Kill routine which will destroy all DA info on the pclient and may also destroy the pclient application software.

Archive:

All changes to status of active records can be archived. Archives can be used to recover various statistics and also for audit of correct practice.
Master Keys
Interim Keys
Custodians
Machines
   DA Register

This unit maintains date and time-stamped encrypted images of currently active and historic versions of DAs. These images are client unique as required and are available for reinstatement. Current images may be used as an image comparison with distributed copies. Hidden characters may be included for enhanced control of copy identification. The master image is the actual DA as known to the DAP system. Variations from this master would require various DAP responses.

Databases: Active pclient (images), Archive pclient.

DAP Log Record

This unit maintains a time-stamped transaction by transaction record of all activity throughout the DAP system. It is used for disaster recovery across the system. It is also used as a source of information to be analyzed for operational and functional correctness of the DAP system.

Hackers attempting to compromise the DAP system will probably seek to scrub log files. Therefore all scrubbing is to be validated before executing.

Architecture—pclient

pclient setup and initialize (use Skey for setup encryption)
pclient control
   Startup (hands-on or secure CD)
   Integrity (PCL01, PCL05), (BIOS, C++ and DOS)
   Violations (PCL02), (C++ and DOS)
   Poison pill
      Change administration (PCL09) (BIOS and C++)
   Read (PCL03, PCL10) (application, Windows, DOS, C++)
   Write (PCL04, PCL11) (application, Windows, DOS, C++)
   pclient administration
      Response requests (C++)
         Machine custody check (PCL06)
         Plevel synch check
      Changes (BIOS and C++)
         DA plevels (PCL07)
         Custodian plevels (PCL08)
   Communications and signals (C++)
      POST Level
      Power-on Control Monitor:

DAP is potentially exposed where a distributed laptop is not presented to the network. Non-presentation precludes timely validation of DAP status etc. In such cases various power-related factors can be limited, for example the number of power-on's between successive network connections, length of power-on, or a given duration of date/time. Exceeding this limit may optionally trigger an automatic pclient response which may be extremely drastic in the interests of denying access by unauthorized or no longer authorized persons to the DAs currently resident on the machine. (Operate module AA)

Check physical machine value against value recorded in poison pill on HDD from pcentral key register. A mismatch indicates HDD in wrong machine. If this machine is also not connected to network then do KILL to data and pclient. If network connected reports to pcentral and seeks response before continuing. Any interrupt does KILL. (Operate module LL)

Non-DAP Bypass

DAP can allow immediate and unrestricted bypass for all non-DA records. This is done to avoid any unnecessary processing overheads for records, which do not require this (identified by encrypted plevel of protection). This bypass is protected and monitored to ensure it is not a point of system corruption. Bypasses may be recorded on the DAP Log Record for later perusal. (Operate module TT)

Communication Interface

All interactions DAP Central are managed through this module.

Exception Handler

Exceptions identified by pclient and pcentral resident functions or advised by pcentral Communications Controller are handled at this point. It is considered that a focal point enables multiple exceptions to be considered in sum and may attract a higher-level protection response than would apply for a single exception.

Client Creates DA

A custodian may create a DA whilst machine not connected network/pcentral. All output files created in the session opening a DA with a selected plevel to be centrally logged for subsequent analysis. This requirement to be coupled with a mandatory network connection or Kill. (Operate module EE)

Encryption Handler

This unit can apply all encryption and decryption routines. Encryption whilst network connected does not rely on pcentral to complete encryption process. Encryption whilst not connected to rely on module RR. (Operate module RR).

I/O Interruption Handler

(Operate Module DD (Interdict Local Output Function))

This unit manages interdiction of local output attempts of DA data (encrypted or decrypted). The I/O commands, for example, including Print screen, Copy file to HDD, FDD or CD burn, Print file, Print Screen; are interdicted at device interface level and constrained as required by ‘plevel’ status.

This unit is protected by operating within the control of Poison Pill and attempts to subvert will cause immediate Kill to be activated and message to that effect transmitted to pcentral.

If the Custodian attempts to create a file (not initially identified as a DA) the following process may apply to trap this event and apply correct DAP control. The file will be assembled on the local machine's temporary workspace. A Save will be attempted by either a timed save via Windows product or a manual initiated save via the Save icon. In either case this unit will interdict the write attempt. Module JJ will be called and a DA key phrase recognition table checked against created content. If no match proceed as per non-DA material. If match found call encryption prior to write and create txn to Central. It is anticipated that this routine can be progressively hardened with possible H/W function and frequent validation of integrity.

Poison Pill

Operate module BB (poison pill validity check)
Operate module CC (Missing machine reported, HDD mismatch)
Operate module GG (Kill)

This unit contains the protection devices at the pclient level. Certain interfaces between Sub-Window functions, pclient and pcentral are managed by this module. It can be frequently validated and possibly re-established without operator intervention. Any identification of attempts to subvert integrity can be responded to via this module.

Checks are maintained between this pclient and the machine identification value(s). This checks identifies any situation where a HDD has been removed from an authorized machine and inserted in an unknown machine.

Guardian Interface

This unit can optionally be provided to manage relation to Guardian requirements as applicable to pclient. Guardian function audits and protection integrity may be checked at any time. Protection mechanisms may be reloaded with variations to maximize pclient level protection.

DAP Multiples Interface

This unit can manage the relationship between requirements instituted by hierarchical DAP systems. It expected that independent and concurrent DAP involvement by an individual can be implemented via a shadow client with the shadow managing all functions required to be unique.

Coding Structures:

| | Pcentral | pclient |
|---|---|---|
| DAP exec | | |
| Procedures | PCO01-PCO11 | PCL01-PCL12 |
| Modules | AACO-ZZCO | AACL-ZZCL |
| Data structures | DSCO01-DSCO10 | DSCL01-DSCLnn |
| xxxxxxxxxxxxxxxx | xxxxxxxxxxxxxxx | xxxxxxxxxxxxxxx |
| xxxxxxxxxxx | xxxxxxxxxxxx | xxxxxxxxxxxx |
| DAP install | | |
| Procedures | IPCOnn | IPCLnn |
| Modules | IMCOaa | IMCLaa |
| Data structures | IDSCOnn | IDSCLnn |

### III. Further Detailed Example

The following further example provides a detailed outline of a preferred embodiment of the present invention. The example embodiment presented is intended to be merely illustrative and not limiting to the scope of the present invention. The example makes reference to numerous figures to assist with the description of the particular embodiment of the present invention.

This particular embodiment includes:
Digital Asset Protection for selected data files or documents (DAs);
A central control system storing digital asset master documents, encryption keys and security and general administration database;
A client terminal able to communicate via a computer network with the central control system;
A client software resident on the client terminal to allow the client terminal to read, update and create digital asset copies whether or not they are connected to the central control system;
A communication controller machine (also known as proxy or firewall) to hide the central server to client terminals;
Encryption of digital asset masters on the central terminal using pluggable encryption protocols;
Encryption of digital asset copies on client terminals using pluggable encryption protocols;
Encryption of communications between the client terminals and the central server using Secure Sockets Layer (“SSL”);
Protection using a ‘protection level’ (also known as “plevel”);
A poison pill module;
A power-on control monitor;
A log record of all digital asset accesses on client terminals, whether or not they are connected to the central control system; and,
A DA-recogniser module, implemented as a phrase checker.

As further clarification, the following terms are used herein as defined below:

| Term | Meaning |
|---|---|
| pcentral | Central Control System |
| pclient | Client Terminal |
| Proxy or | Communication Controller Machine |
| Firewall | |
| plevel | Protection level of Digital Assets and Clearance level of |
| | custodians |
| POST-count | Power-On-Self-Test (or Reboot) count |
| DA | Digital Asset |
| DAP | Digital Asset Protection software package |
| Custodian | User or users configured through the system to access |
| | digital assets |
| Locked Process | Process which has opened a digital asset |
| Unlocked | Process which has not yet opened a digital asset |
| Process | |
| Sanitise | Complete deletion of a data file or files from persistent |
| | storage media by overwriting all addressable locations |
| | with a character, its complement, then a random |
| | character and verify, in compliance with US Department |
| | of Defence in the clearing and sanitising standard DoD |
| | 5220.22-M. |

Architecture Overview

This particular embodiment is being further extended for an enhanced embodiment integrating, for example but not limited to, support for multiple or linked DAP systems, support for group-based authentication, links to external audit processes, single logical access to multiple physical databases, etc.

This particular embodiment is intended for use on Microsoft Windows NT-derived systems (NT 4.0, Windows 2003, Windows XP and Windows 2003 server). Also, in this particular embodiment only, digital assets are limited to Microsoft Office documents (Word, Excel, PowerPoint). Obviously, other embodiments can be readily developed that relate to any other type of system (including, but not limited to, Unix, Linux, Mac OS, etc.), document or file type. Other particular embodiments may also provide for: Support of multiple or linked DAP's; External check/audit of DAP process; Facilitation of single logical access to multiple physical database locations as a single logical read; and/or portability and platform independence.

Use Cases

PClient Installation:

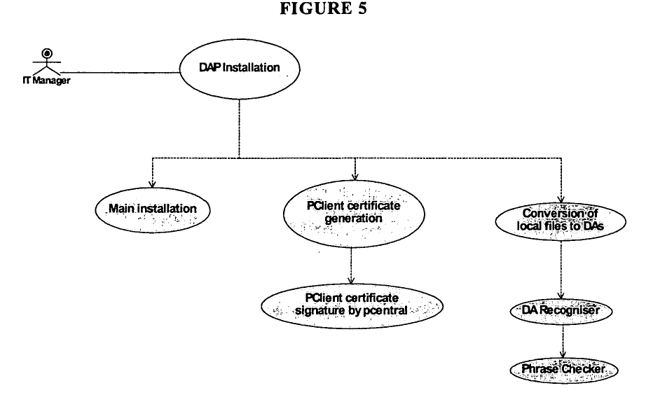

The pclient DAP installation is performed using a standard install.exe file. This installation can either be performed after Windows NT installation, or on demand (‘pushed’ by pcentral using some distribution software or explicitly installed by the custodian using the DAP install software on CD or network drive). The installation comprises the main software installation, pclient digital certificate generation (and digital signature by pcentral) and conversion of the existing ‘sensitive’ documents to Digital Assets. This process is illustrated in FIG. 5.

PClient POST Check:

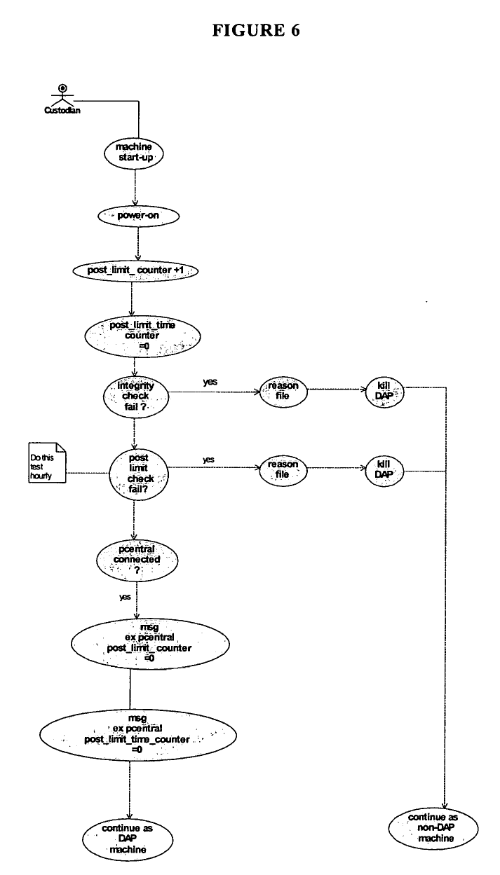

Each time the machine is rebooted, it performs a simple POST check, consisting (in this particular implementation) of counting the number of reboots since the last connection to pcentral. Other implementations can include other tests and checks to enable control and enforce periodic connection to pcentral as required by the end-user organisation's business rules. This process is illustrated in FIG. 6.

PClient Integrity Check:

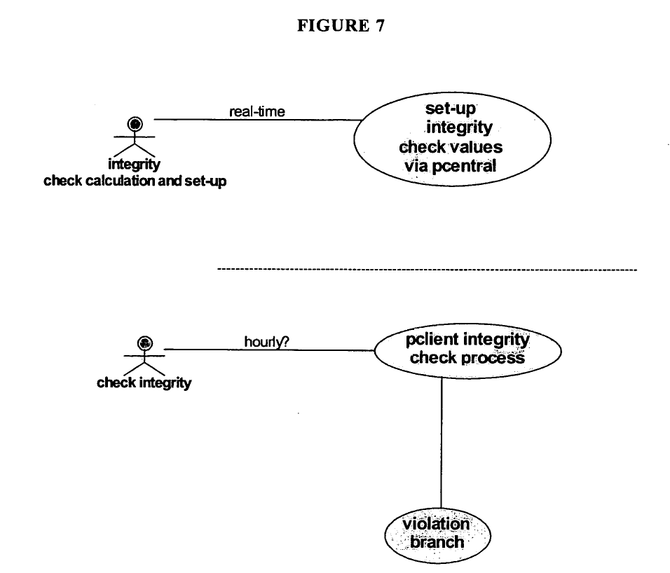

Pclient permanently (in real time and at given intervals) checks its integrity and attempts to detect intrusion attempts. This process is illustrated in FIG. 7.

PClient Integrity Violation:

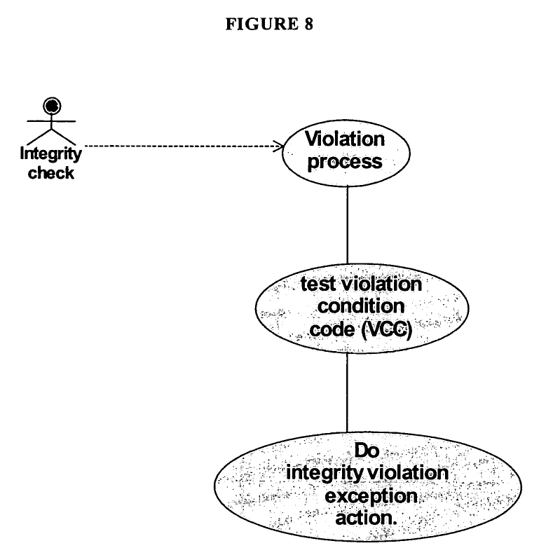

If an integrity violation is detected, an exception procedure is initiated, resulting in the KILL process. This process is illustrated in FIG. 8.

PClient Kill:

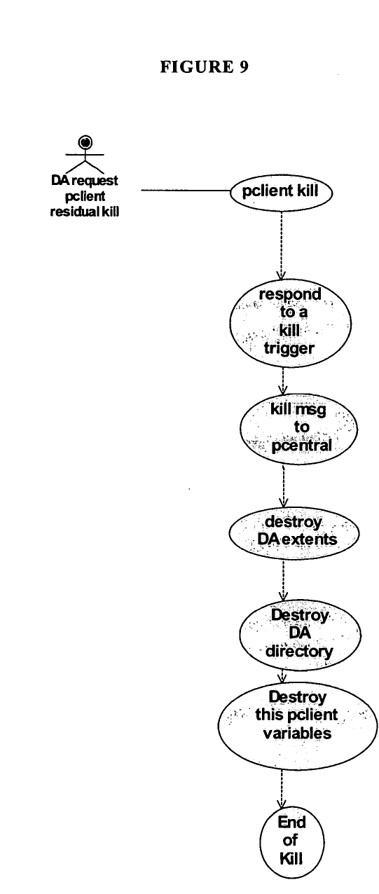

The KILL process is initiated when the POST count reaches the preset limit, or when the integrity of the system is corrupted. It comprises sanitising all digital assets and other sensitive information on the pclient machine. This process is illustrated in FIG. 9.

PClient Custodian Authentication:

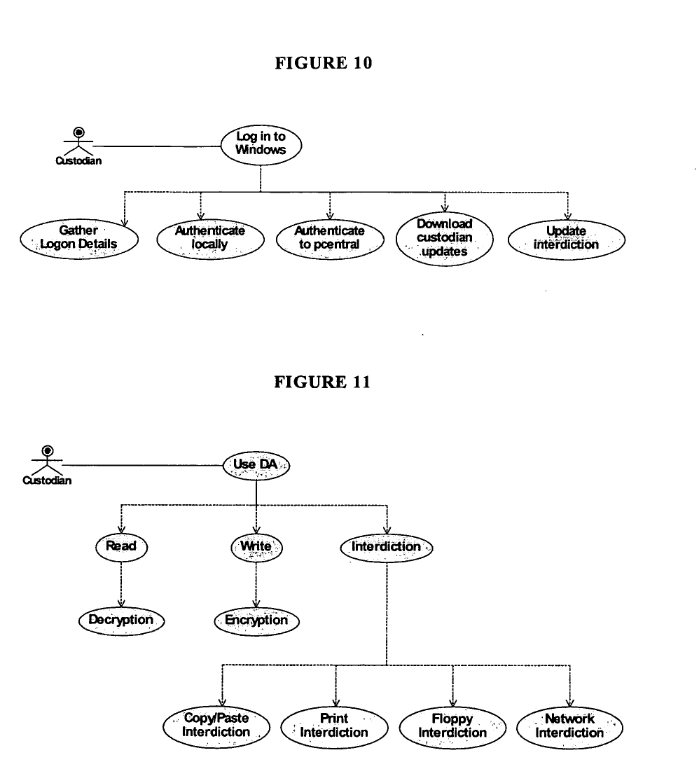

The custodian authentication is performed transparently as an authorised user logs into Windows and enters his or her Windows account details. The DAP authentication procedure attempts to connect to pcentral, download any updates (plevel changes etc.) and, if pcentral is not available, check if the custodian is allowed to access digital assets in a disconnected mode. This process is illustrated in FIG. 10.

PClient DA Encryption/Decryption/Interdiction:

All digital asset activity is interdicted as specified in an organisation's business rules. When reading from a digital asset, its content is decrypted from a disk. When writing to a digital asset, its content is encrypted. This process is illustrated in FIG. 11.

PClient DA Copy Management:

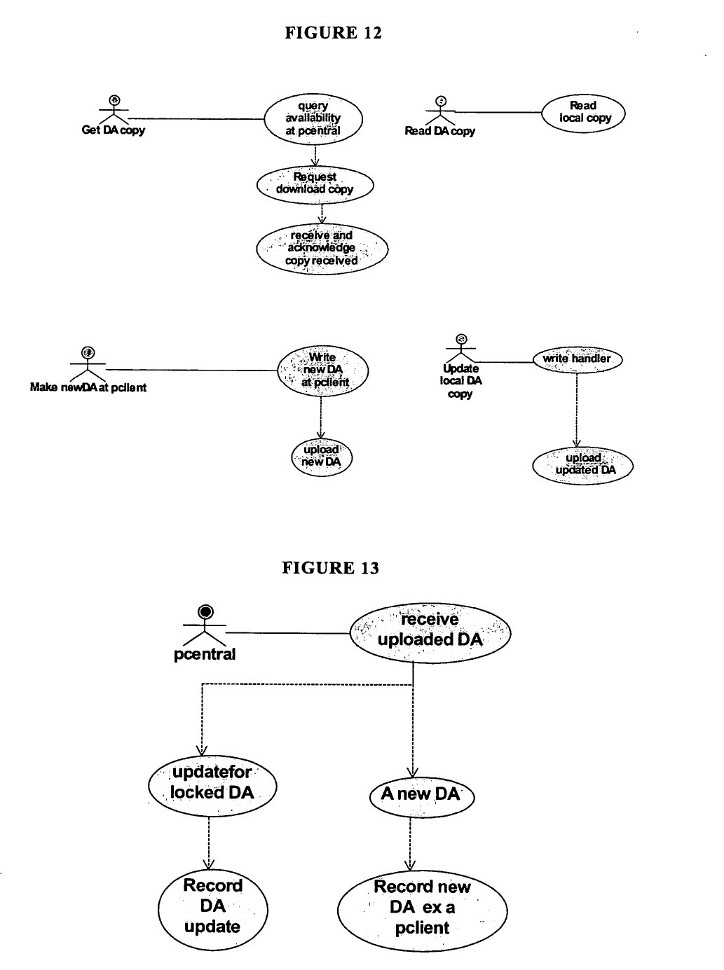

Only digital asset copies are stored on pclient. The custodian can request a digital asset copy from pcentral, read and update it, and even create new digital assets. New digital assets are uploaded to pcentral as soon as possible (as soon as pclient connects to pcentral). This process is illustrated in FIG. 12.

PClient DA Copy Upload:

New and updated digital assets are uploaded to pcentral as soon as they are created/updated. This process is illustrated in FIG. 13.

PClient Log Management:

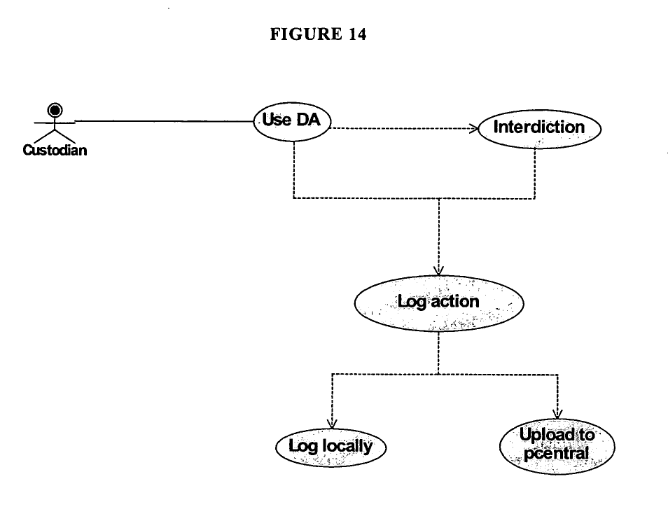

Each use (authorised or interdicted) of a digital asset is logged. Logs are immediately uploaded to pcentral if possible, or cached on pclient if pcentral is unavailable. This process is illustrated in FIG. 14.

PCentral Installation:

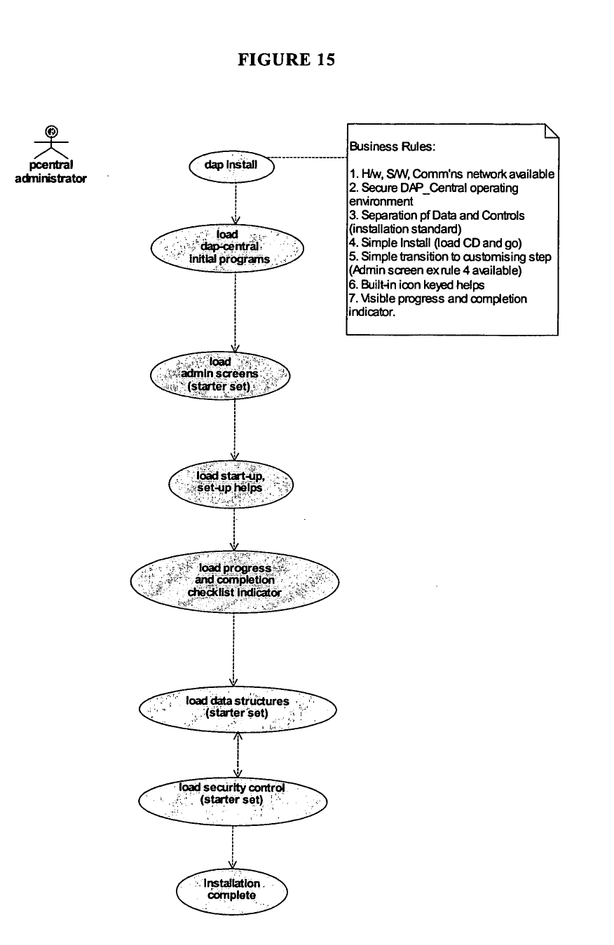

PCentral installation comprises the DAP software installation and its configuration. This process is illustrated in FIG. 15.

PCentral Customisation and Administration:

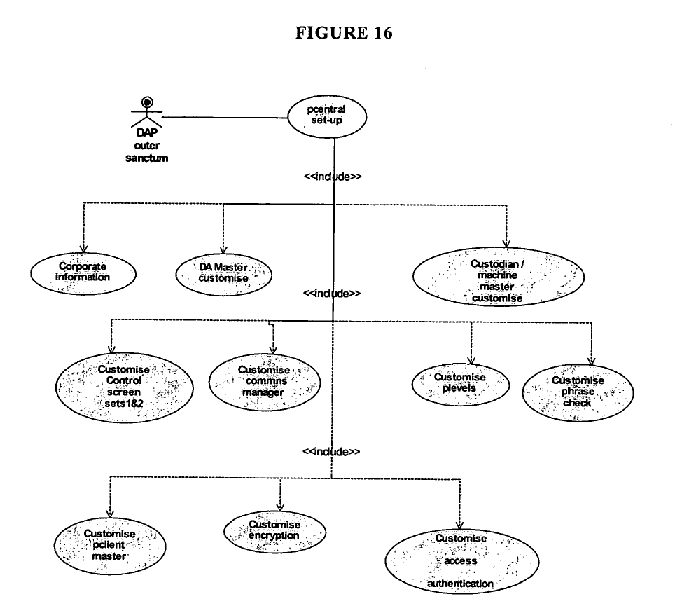

An administration graphical user interface (“GUI”) is provided to customise and administer pcentral. IT Managers use this GUI to configure security, encryption, business rules, administer digital assets and monitor logs. This process is illustrated in FIG. 16.

PCentral Audit Checks:

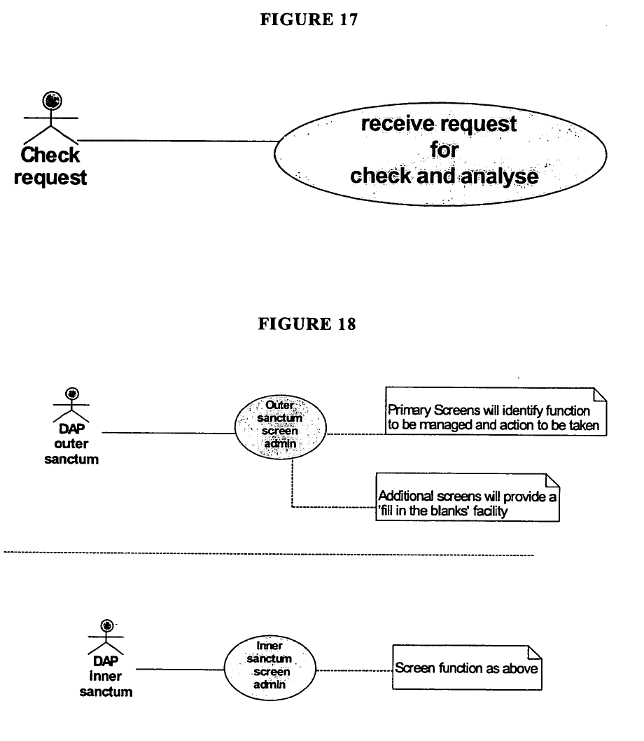

IT Managers can request audit checks. These audit checks are forwarded to pclient machines. Results are collected by pcentral and stored in the pcentral database for further analysis. This process is illustrated in FIG. 17.

PCentral Administration:

Depending on whether the administration GUI is run from within the inner-sanctum (a secure part of the system between the proxy and pcentral) or in the outer-sanctum, different functions apply. This process is illustrated in FIG. 18.

PCentral Pclient/Custodian Authentication:

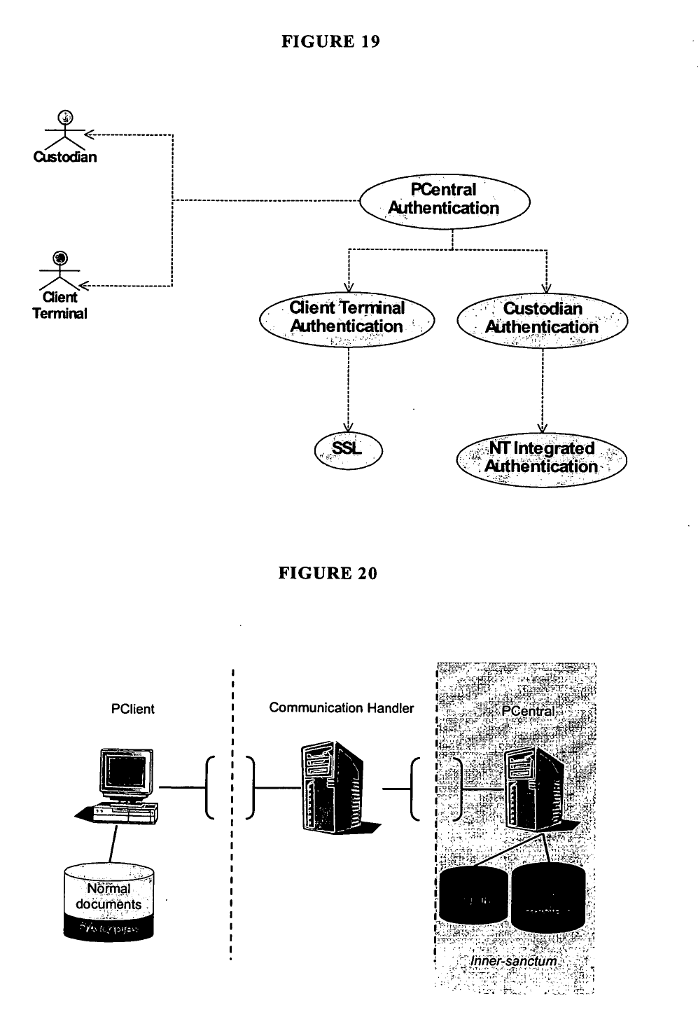

Both custodian and client terminal (pclient) are securely authenticated by pcentral. The former is authenticated using the custodian's Windows login credentials, and the latter using SSL certificates. This process is illustrated in FIG. 19.

Architecture High Level Design

Interdiction:

The interdiction is OS-dependant. Windows NT (and subsequent versions), is organised in layers (Win32 API on top of the native API, on top of device drivers, on top of the kernel API . . . ), so interdiction takes place at different levels, depending on the type of API to interdict. For example, the clipboard interdiction takes place at the Win32 level, but the disk interdiction takes place at the file system level.

Encryption:

Digital asset encryption on disk is performed at the file system level. The encryption is implemented in such a way that different encryption algorithms can be plugged-in depending on customers' requirements.

Files on disk are encrypted using a unique symmetrical key (very fast and secure). The symmetrical key is, itself, encrypted with a public/private key which depends on the custodian and plevel. This key pair may in some cases (when the custodian is allowed to access digital assets when not connected to pcentral) need to be stored on the disk itself. It should therefore be encrypted with the custodian password. Therefore, if the custodian changes his or her password, only the public/private keys need to be re-encrypted (and not the digital assets themselves).

As often users have several accounts (one local laptop account and a domain account), public/private keys can be shared between custodians.

Authentication of Custodian, PClient and Pcentral:

In this particular embodiment, the DAP system authenticates custodians by using the Windows single sign-on capabilities: as soon as Windows authenticates the custodian, DAP takes over and can authorise access to digital assets. Other embodiments can incorporate alternative authentication modules including, for example, biometrics such as fingerprint or iris scanning.

If connected to the network, pclient sends the user credentials (domain, user and encrypted password) to pcentral which then authenticates the custodian internally, and sends any pending updates (such as plevel changes). To make sure nobody impersonates a pcentral or a pclient machine, SSL certificates are used in this embodiment.

Secure Communication Between Pclient and Pcentral:

SLL is also used to provide secure and encrypted communication between pclient and pcentral.

Use of a Communication Handler:

A communication handler (also know as a proxy or firewall) is used to isolate pcentral from the outside world (which, for example, may be a company's intranet).

Custodian and Digital Asset Monitoring and Tracking:

Each access to a digital asset is closely monitored by pclient. Logs are immediately sent to pcentral if possible, or cached locally in an encrypted, hidden and interdicted file if disconnected. Logs are automatically uploaded as soon as pcentral becomes accessible.

Programming Languages:

As the pclient module is mostly a low-level driver providing low-level interdiction and encryption, C++ is used in this particular embodiment. On the other hand, pcentral and the communication handler are not system-dependant and can run on any platform. Java is used to provide platform-independence.

Database Access and Independence:

Java Database Connectivity (“JDBC”) is used to access the DAP database. This means DAP is able to connect to virtually any database provider.

Business Rules:

In this particular implementation, the following Business Rules have been chosen.

Obviously, these rules could be significantly changed in other embodiments.
Once a process opens a digital asset, the process will remain ‘Locked’ until it terminates, even if it closes all its digital assets;
Locked processes can open non-DAs Read Only;
If a process opens a digital asset but had some non-DA files previously opened, these files become Read Only;
All files, including temporary files, created by a Locked process are created as digital assets;
Some internal files are totally interdicted to all non-internal processes;
Locked processes are not be able to copy data to the clipboard;
Locked processes are not be able to print any data;
Locked processes are not be able to send any data over a network connection;
After a configurable number of reboots without connecting to pcentral, the machine is sanitised;
Digital asset masters and copies are encrypted whenever stored on a persistent media;
A custodian is only able to see and download digital asset copies from digital asset masters whose plevel is less than or equal to their own plevel;
A custodian is only able to see and open digital asset copies which he/she has created himself/herself;
If a custodian plevel is lowered, the custodian instantly loses access to previous files he/she created with his/her previous plevel;
Digital assets are, by default, created with the custodian's own plevel.
   Architecture Diagram:

Illustrated in FIG. 20 is the architecture selected for this particular embodiment. PClient's hard drive contains normal documents and digital asset copies. It communicates with pcentral through its communication handler. Digital asset masters and general administration information are kept in the inner-sanctum, only accessible by pcentral.

Database Diagram:

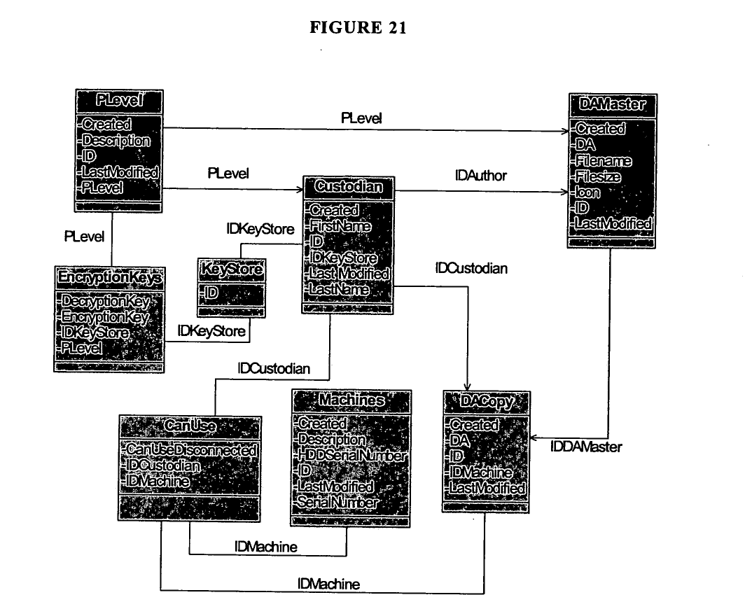

Illustrated in FIG. 21 is a database structure selected for this particular embodiment. This database diagram is not exhaustive, but details important tables of the DAP system.

PClient Architecture Diagram:

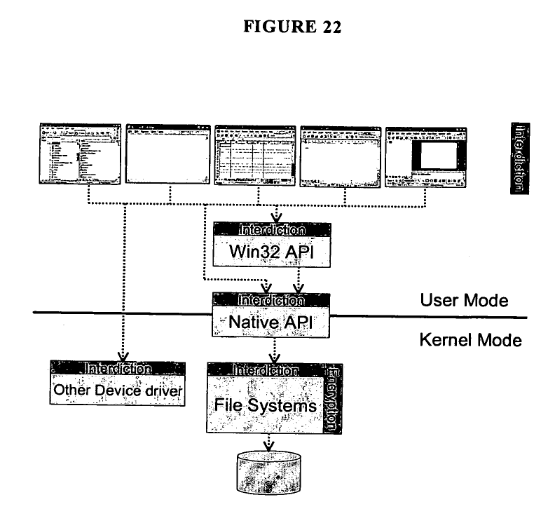

Illustrated in FIG. 22 is the pclient architecture selected for this particular embodiment. This diagram illustrates the different levels of interdiction present in pclient.

Thus, there has been provided in accordance with the present invention, a method, system and/or computer readable medium of instructions for providing protection for digital assets.

The invention may also be said to broadly consist in the parts, elements and features referred to or indicated herein, individually or collectively, in any or all combinations of two or more of the parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the scope of the present invention.

1-52. (canceled)

53. A system for providing protection for identified digital assets, the system including:
(1) a central control system;
(2) a client terminal able to communicate via a computer network with the central control system;
(3) client software resident on the client terminal;
(4) a master copy of a digital asset stored on the central control system;
(5) an encrypted copy of the digital asset stored on the client terminal, with an encryption key for the encrypted copy of the digital asset stored on the central control system and the client terminal;
whereby, the client software resident on the client terminal controls access by a custodian to the copy of the digital asset stored on the client terminal, and the custodian's level of access to the copy of the digital asset stored on the client terminal can be altered from the central control system.

54. The system as claimed in claim 53, wherein when access is initially requested to the encrypted copy of the digital asset by the custodian the client software attempts to communicate with the central control system and authenticate the initial access request.

55. The system as claimed in claim 53, wherein when access is properly requested to the encrypted copy of the digital asset residing on the client, and the client terminal is disconnected from the central control system, the copy of the digital asset can be decrypted and used by the custodian with defence mechanisms active.

56. The system as claimed in claim 53, wherein the digital asset is assigned a level of protection, and the at least one custodian is assigned a level of authorisation.

57. The system as claimed in claim 56, wherein different levels of protection/authorisation allow varying use of each copy of the digital asset.

58. The system as claimed in claim 54, wherein:
(A) if the central control system authenticates an initial access request, a private decryption key is used to enable the encrypted copy of the digital asset to be decrypted; or,
(B) if the central control system does not authenticate the initial access request, the decryption key is not available to be used to decrypt the encrypted copy of the digital asset.

59. The system as claimed in claim 53, wherein the central control system includes a communications controller and a encryption key register.

60. The system as claimed in claim 53, wherein the central control system includes a digital asset register to store current and previous master copies of the digital asset.

61. The system as claimed in claim 53, wherein the central control system includes a digital asset register to register and store each encrypted copy that has been distributed at the request of a properly authenticated client terminal.

62. The system as claimed in claim 53, wherein the central control system includes a digital asset log record.

63. The system as claimed in claim 60, wherein the central communications controller includes a client communications module and a central communications module.

64. The system as claimed in claim 53, wherein the central control system is provided by at least two physical servers.

65. The system as claimed in claim 64, wherein the communications controller is resident on a first server, and the encryption key register is resident on a second server.

66. The system as claimed in claim 65, wherein all functions other than the communications controller are resident on the second server.

67. The system as claimed in claim 60, wherein the encryption key register stores additional information for the authentication of any request to copy a digital asset.

68. The system as claimed in claim 67, wherein the additional information relates to the identity of the custodian and/or a specific authorised client terminal.

69. The system as claimed in claim 53, wherein each client software package uniquely controls the decryption process for a particular client terminal.

70. The system as claimed in claim 53, wherein the client software controls access and/or destruction of the copy of the digital asset.

71. The system as claimed in claim 53, wherein the client software includes a poison pill module.

72. The system as claimed in claim 71, wherein the poison pill module can cause the destruction of the copy of the digital asset.

73. The system as claimed in claim 71, wherein the poison pill module checks a retrieved value identifying the client terminal, or a component thereof, against an expected identification value.

74. The system as claimed in claim 71, wherein the poison pill module checks a component of a hash sum value, combined with custodian information, a client terminal and hardware reference against expected values.

75. The system as claimed in claim 53, wherein the client software includes a power-on control monitor.

76. The system as claimed in claim 53, wherein the client software includes a communications interface.

77. The system as claimed in claim 53, wherein the client software includes an exception handler.

78. The system as claimed in claim 53, wherein the client software includes an encryption handler.

79. The system as claimed in claim 53, wherein the client software includes an I/O interruption handler.

80. The system as claimed in claim 57, wherein authorisation and protection levels can be updated on the central control system and transmitted to the client software on the client terminal.

81. The system as claimed in claim 53, wherein the master copy of the digital asset stored on the central control system is encrypted.

82. A method of providing protection for digital assets, the method including the steps of:
(1) storing an encrypted master copy of a digital asset on a central control system;
(2) storing a separate encrypted copy of the digital asset on a client terminal provided with client software, the client terminal able to communicate via a computer network with the central control system;
(3) storing an encryption key for the encrypted copy of the digital asset on the central control system and the client terminal; and,
(4) when access is properly requested by an authorised custodian to the encrypted copy of the digital asset residing on the client terminal, and the client terminal is disconnected from the central control system, the client software controls access to the copy of the digital asset.

83. The method as claimed in claim 82, wherein when access is initially requested to the encrypted copy of the digital asset by the custodian the client software attempts to communicate with the central control system and authenticate the initial access request.

84. The method as claimed in claim 82, wherein the digital asset is assigned a level of protection, and the custodian is assigned a level of authorisation.

85. The method as claimed in claim 84, wherein different levels of protection/authorisation allow varying use of the copy of the digital asset.

86. The method as claimed in claim 82, wherein the frequency of computer network connection is monitored by the client software.

87. The method as claimed in claim 82, wherein access restrictions to the digital asset can be varied from the central control system.

88. The method as claimed in claim 82, wherein the master copy of the digital asset is encrypted.

89. The method as claimed in claim 82, wherein a unique encryption key is created for each custodian and each distributed copy of the digital asset.

90. The method as claimed in claim 82, wherein if preset criteria are not met the client software can effect destruction of the encryption key, the copy of the digital asset on the client terminal, the contents of memory and/or storage facilities of the client terminal, and/or BIOS information for the client terminal.

91. The method as claimed in claim 82, wherein the copy of the digital asset is destroyed if successful network connection to the central control system is not achieved after a preset number of attempts and/or a preset time period.

92. The method as claimed in claim 82, wherein the central control system tracks the location of all copies of each digital asset.

93. The method as claimed in claim 82, wherein a newly created digital asset is uploaded to the central control system to create a master copy of the digital asset.

94. The method as claimed in claim 82, wherein the copy of the digital asset is periodically re encrypted and redistributed.

95. The method as claimed in claim 82, wherein a poison pill module is provided.

96. The method as claimed in claim 95, wherein the poison pill module can delete/overwrite the copy of the digital asset, destroy the client software, and/or inactivate the client terminal BIOS.

97. The method as claimed in claim 82, wherein print and copy functions of the client terminal can be optionally disabled by the client software.

98. The method as claimed in claim 82, the method able to be performed utilising the system of claim 53.

99. A computer readable medium of instructions for providing protection for digital assets in a system including:
(1) a central control system;
(2) a client terminal able to communicate via a computer network with the central control system;
(3) a master copy of a digital asset stored on the central control system;
(4) an encrypted copy of the digital asset stored on the client terminal, with the encryption key for the encrypted copy of the digital asset stored on the central control system and the client terminal;
whereby the computer readable medium of instructions is adapted to control access by a custodian to the copy of the digital asset stored on the client terminal, and the custodian's level of access to the copy of the digital asset stored on the client terminal can be altered from the central control system.

100. The computer readable medium of instructions as claimed in claim 99, wherein the computer readable medium of instructions is client software.

101. The computer readable medium of instructions as claimed in claim 100, wherein the client software controls the decryption process.

102. The client software as claimed in claim 99, wherein the client software controls access and/or destruction of the copy of the digital asset.

103. The client software as claimed in claim 99, wherein the client software includes a poison pill module.

104. The client software as claimed in claim 103, wherein the poison pill module checks a retrieved value identifying the client terminal, or a component thereof, against an expected identification value.

105. The client software as claimed in claim 99, wherein the client software includes:
a power on control monitor;
a communications interface;
an exception handler;
an encryption handler; and/or,
an I/O interruption handler.
